(19) United States
(12) Patent Application Publication
(10) Pub. No.: US 2025/0280209 A1
(43) Pub. Date: Sep. 4, 2025

(54) INFORMATION PROCESSING DEVICE AND INFORMATION PROCESSING METHOD

(71) Applicant: CANON KABUSHIKI KAISHA, Tokyo (JP)

(72) Inventors: DAISAKU MORIWAKI, Tokyo (JP); KOKI HONDA, Kanagawa (JP)

(21) Appl. No.: 19/065,834

(22) Filed: Feb. 27, 2025

(30) Foreign Application Priority Data
Feb. 29, 2024 (JP) 2024-029712

(51) Int. Cl. H04N 25/633; G06T 5/20; G06T 5/70; H04N 25/779

(52) U.S. Cl. CPC H04N 25/633; G06T 5/20; G06T 5/70; H04N 25/779

(57) ABSTRACT

An information processing device includes a first storage unit storing first array data based on a pixel value output from each pixel, a second storage unit storing second array data including a plurality of coefficients used for correcting the pixel value, a first arithmetic operation unit correcting a pixel value of a first target pixel in the first array data, based on the pixel value of the first target pixel, a pixel value of a second target pixel adjacent to the first target pixel in the first array data, and the second array data, a third storage unit storing third array data based on the pixel value output from the first arithmetic operation unit, a second arithmetic operation unit detecting a third target pixel from the third array data, and a third arithmetic operation unit correcting a pixel value of the third target pixel based on the third array data.

### BACKGROUND OF THE INVENTION

### Field of the Invention

The present disclosure relates to an information processing device and an information processing method.

### Description of the Related Art

U.S. Patent Application Publication No. 2007/0030365 discloses a method for correcting a defective pixel. U.S. Patent Application Publication No. 2007/0030365 discloses a method for specifying a defective pixel and replacing an output value of the defective pixel with an average value of output values of surrounding pixels.

However, accuracy of the correction may not be sufficient in the correction method as described in U.S. Patent Application Publication No. 2007/0030365.

### SUMMARY OF THE INVENTION

An object of the present disclosure is to provide an information processing device and an information processing method with improved correction accuracy.

According to a disclosure of the present specification, there is provided an information processing device including a first storage unit configured to store first array data based on a pixel value output from each of a plurality of pixels, a second storage unit configured to store second array data including a plurality of coefficients used for correcting the pixel value, a first arithmetic operation unit configured to correct a pixel value of a first target pixel in the first array data, based on the pixel value of the first target pixel, a pixel value of a second target pixel adjacent to the first target pixel in the first array data, and the second array data, a third storage unit configured to store third array data based on the pixel value output from the first arithmetic operation unit, a second arithmetic operation unit configured to detect a third target pixel from the third array data, and a third arithmetic operation unit configured to correct a pixel value of the third target pixel based on the third array data.

According to a disclosure of the present specification, there is provided an information processing device including a first arithmetic operation unit configured to correct a pixel value of a first target pixel in first array data based on a pixel value output from each of a plurality of pixels, based on the pixel value of the first target pixel, a pixel value of a second target pixel adjacent to the first target pixel in the first array data, and second array data including a plurality of coefficients, and a third arithmetic operation unit configured to correct a third target pixel detected from third array data based on a pixel value output from the first arithmetic operation unit

According to a disclosure of the present specification, there is provided an information processing method including acquiring first array data based on a pixel value output from each of a plurality of pixels, acquiring second array data including a plurality of coefficients used for correcting the pixel value, correcting a pixel value of a first target pixel in the first array data, based on the pixel value of the first target pixel, a pixel value of a second target pixel adjacent to the first target pixel in the first array data, and the second array data, acquiring third array data based on the corrected pixel value of the first target pixel, detecting a third target pixel from the third array data, and correcting a pixel value of the third target pixel based on the third array data.

Further features of the present invention will become apparent from the following description of exemplary embodiments with reference to the attached drawings.

### BRIEF DESCRIPTION OF THE DRAWINGS

FIG. 1 is a schematic diagram illustrating an overall configuration of a photoelectric conversion device according to a first embodiment.

FIG. 2 is a schematic block diagram illustrating a configuration example of a sensor substrate of the photoelectric conversion device according to the first embodiment.

FIG. 3 is a schematic block diagram illustrating a configuration example of a circuit substrate of the photoelectric conversion device according to the first embodiment.

FIG. 4 is a schematic block diagram illustrating a configuration example of a photoelectric conversion unit and a pixel signal processing unit of one pixel of the photoelectric conversion device according to the first embodiment.

FIG. 5A, FIG. 5B, and FIG. 5C are diagrams for describing an operation of an avalanche photodiode of the photoelectric conversion device according to the first embodiment.

FIG. 6 is a schematic explanatory diagram illustrating correction processing executed in an information processing device according to the first embodiment.

FIG. 7 is a block diagram of a photoelectric conversion system according to the first embodiment.

FIG. 8 is a flowchart of processing executed in the photoelectric conversion system according to the first embodiment.

FIG. 9 is a schematic explanatory diagram illustrating correction processing executed in an information processing device according to a second embodiment.

FIG. 10 is a block diagram of a photoelectric conversion system according to the second embodiment.

FIG. 11 is a flowchart of processing executed in the photoelectric conversion system according to the second embodiment.

FIG. 12 is a block diagram of equipment according to a third embodiment.

FIG. 13A and FIG. 13B are block diagrams of equipment according to a fourth embodiment.

### DESCRIPTION OF THE EMBODIMENTS

Preferred embodiments of the present invention will now be described in detail in accordance with the accompanying drawings. The same or corresponding elements are denoted by the same reference numerals throughout the drawings, and the description thereof may be omitted or simplified.

### First Embodiment

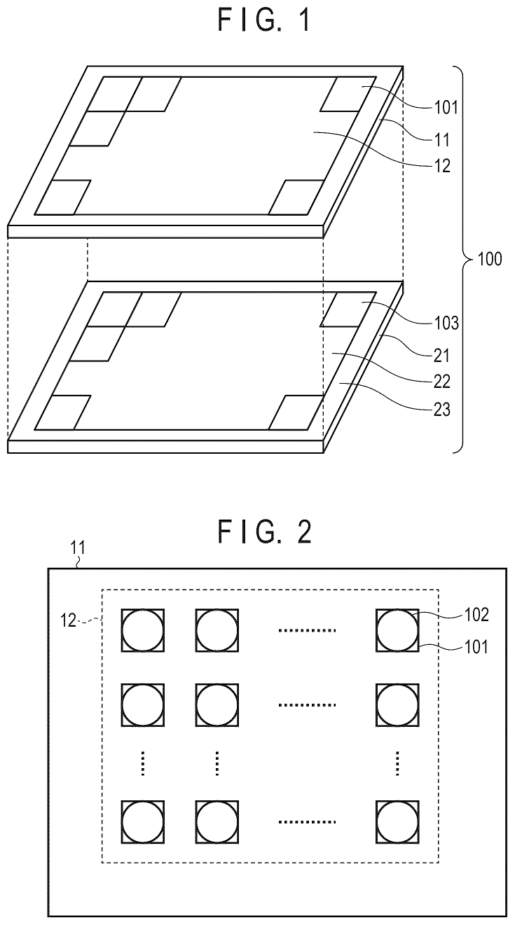

An information processing device according to the present embodiment is a device that processes image data acquired by a photoelectric conversion device. Prior to a description of the information processing device, a configuration and an operation of the photoelectric conversion device will be described with reference to FIGS. 1 to 5C. Note that, in the description, it is assumed that the information processing device is provided outside the photoelectric conversion device, and the photoelectric conversion device and the information processing device form a photoelectric conversion system. However, for example, the information processing device may be disposed in the photoelectric conversion device.

FIG. 1 is a schematic diagram illustrating an overall configuration of a photoelectric conversion device 100 according to the present embodiment. The photoelectric conversion device 100 includes a sensor substrate 11 and a circuit substrate 21 stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 has a first circuit region 22 in which a plurality of pixel signal processing units 103 are arranged so as to form a plurality of rows and a plurality of columns, and a second circuit region 23 disposed on an outer periphery of the first circuit region 22. The second circuit region 23 can include a circuit or the like that controls the plurality of pixel signal processing units 103.

The sensor substrate 11 includes a first semiconductor layer including a photoelectric conversion unit 102 described below and a first wiring structure. The circuit substrate 21 includes a second semiconductor layer including a circuit such as a pixel signal processing unit 103 described below and a second wiring structure. The photoelectric conversion device 100 is formed by stacking the second semiconductor layer, the second wiring structure, the first wiring structure, and the first semiconductor layer in this order. The photoelectric conversion device 100 is a back-illuminated photoelectric conversion device in which light is incident from a first surface of the first semiconductor layer, and the circuit substrate 21 is disposed on a second surface side of the first semiconductor layer.

Hereinafter, the sensor substrate 11 and the circuit substrate 21 will be described as diced chips, but the sensor substrate 11 and the circuit substrate 21 are not limited to chips. For example, the sensor substrate 11 and the circuit substrate 21 may be wafers. Furthermore, in a case where the sensor substrate 11 and the circuit substrate 21 are diced chips, the photoelectric conversion device 100 may be manufactured by stacking the chips in a wafer state and then dicing the chips, or may be manufactured by dicing and then stacking the chips.

FIG. 2 is a schematic block diagram illustrating a configuration example of the sensor substrate 11 of the photoelectric conversion device 100 according to the present embodiment. In the pixel region 12, the plurality of pixels 101 arranged to form the plurality of rows and the plurality of columns are arranged. Each of the plurality of pixels 101 includes the photoelectric conversion unit 102 including an avalanche photodiode (hereinafter, referred to as APD) as a photoelectric conversion element in the substrate. Typically, the pixel 101 is a circuit that outputs a signal for forming an image, but in a case where the photoelectric conversion device 100 is a sensor used for time of flight (TOF), it is not essential to form an image. For example, the pixel 101 may be a circuit that measures a time when light reaches and a light quantity.

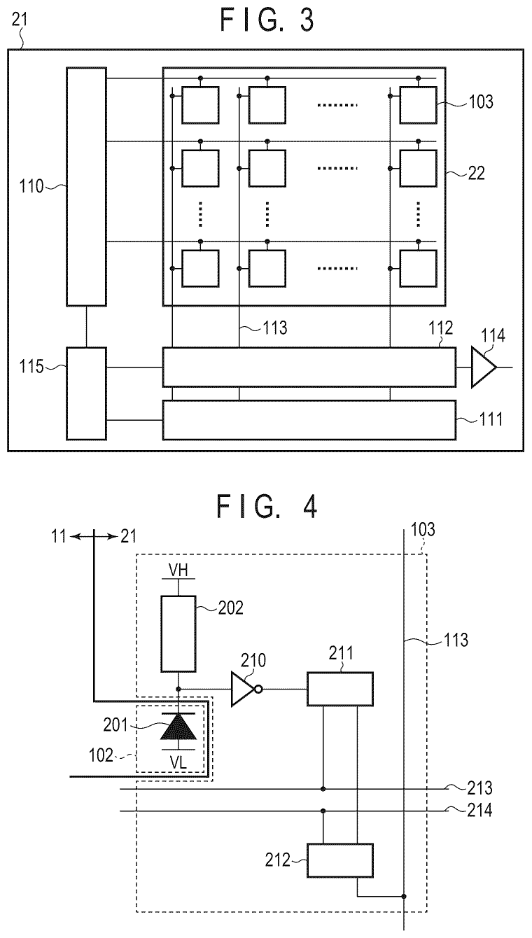

FIG. 3 is a schematic block diagram illustrating a configuration example of the circuit substrate 21 of the photoelectric conversion device according to the present embodiment. The circuit substrate 21 has the first circuit region 22 in which the plurality of pixel signal processing units 103 arranged to form the plurality of rows and the plurality of columns are arranged.

In addition, a vertical scanning circuit 110, a horizontal scanning circuit 111, a reading circuit 112, a pixel output signal line 113, an output circuit 114, and a control signal generation unit 115 are disposed on the circuit substrate 21. The plurality of photoelectric conversion units 102 illustrated in FIG. 2 and the plurality of pixel signal processing units 103 illustrated in FIG. 3 are electrically connected via connection wirings provided for the respective pixels 101.

The control signal generation unit 115 is a control circuit that generates a control signal for driving the vertical scanning circuit 110, the horizontal scanning circuit 111, and the reading circuit 112 and supplies the control signal to these units. As a result, the control signal generation unit 115 controls a drive timing and the like of each unit.

The vertical scanning circuit 110 supplies a control signal to each of the plurality of pixel signal processing units 103 based on the control signal supplied from the control signal generation unit 115. The vertical scanning circuit 110 supplies the control signal for each row to each pixel signal processing unit 103 via a drive line provided for each row of the first circuit region 22. As described below, a plurality of drive lines may be provided for each row. A logic circuit such as a shift register or an address decoder can be used as the vertical scanning circuit 110. As a result, the vertical scanning circuit 110 selects a row in which a signal is to be output from the pixel signal processing unit 103.

A signal output from the photoelectric conversion unit 102 of the pixel 101 is processed by the pixel signal processing unit 103. The pixel signal processing unit 103 includes circuits such as a counter and a memory. The memory of the pixel signal processing unit 103 holds a digital signal.

The horizontal scanning circuit 111 supplies a control signal to the reading circuit 112 based on the control signal supplied from the control signal generation unit 115. The pixel signal processing unit 103 is connected to the reading circuit 112 via a pixel output signal line 113 provided for each column of the first circuit region 22. The pixel output signal line 113 of one column is shared by a plurality of pixel signal processing units 103 of the corresponding column. The pixel output signal line 113 includes a plurality of wirings and has at least a function of outputting the digital signal from each pixel signal processing unit 103 to the reading circuit 112 and a function of supplying, to the pixel signal processing unit 103, a control signal for selecting a column in which a signal is to be output. The reading circuit 112 outputs a signal to a storage unit or a signal processing unit outside the photoelectric conversion device 100 via the output circuit 114 based on the control signal supplied from the control signal generation unit 115.

The photoelectric conversion units 102 in the pixel region 12 may be one-dimensionally arranged. Furthermore, a function of the pixel signal processing unit 103 is not necessarily provided for every pixel 101. For example, one pixel signal processing unit 103 may be shared by the plurality of pixels 101. In this case, the pixel signal processing unit 103 sequentially processes the signals output from each photoelectric conversion unit 102, thereby providing a signal processing function to each pixel 101.

As illustrated in FIGS. 2 and 3, the first circuit region 22 in which the plurality of pixel signal processing units 103 are arranged is disposed in a region overlapping the pixel region 12 in plan view. Then, the vertical scanning circuit 110, the horizontal scanning circuit 111, the reading circuit 112, the output circuit 114, and the control signal generation unit 115 are disposed so as to overlap a region between an end of the sensor substrate 11 and an end of the pixel region 12 in plan view. In other words, the sensor substrate 11 has the pixel region 12 and a non-pixel region disposed around the pixel region 12. In the circuit substrate 21, the second circuit region 23 in which the vertical scanning circuit 110, the horizontal scanning circuit 111, the reading circuit 112, the output circuit 114, and the control signal generation unit 115 are disposed is disposed in a region overlapping the non-pixel region in plan view.

FIG. 4 is a schematic block diagram illustrating a configuration example of the photoelectric conversion unit and the pixel signal processing unit of one pixel of the photoelectric conversion device according to the present embodiment. FIG. 4 schematically illustrates a more specific configuration example including a connection relationship between the photoelectric conversion unit 102 disposed on the sensor substrate 11 and the pixel signal processing unit 103 disposed on the circuit substrate 21. In FIG. 4, drive lines between the vertical scanning circuit 110 and the pixel signal processing unit 103 in FIG. 3 are illustrated as drive lines 213 and 214.

The photoelectric conversion unit 102 includes an APD 201. The pixel signal processing unit 103 includes a quenching element 202, a waveform shaping unit 210, a counter circuit 211, and a selection circuit 212. It is sufficient if the pixel signal processing unit 103 includes at least one of the waveform shaping unit 210, the counter circuit 211, and the selection circuit 212.

The APD 201 generates a charge pair corresponding to incident light by photoelectric conversion. A voltage VL (first voltage) is supplied to an anode of the APD 201. A cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform avalanche multiplication operation is supplied to the anode and the cathode of the APD 201. In the APD 201 to which the reverse bias voltage is supplied, when a charge is generated by incident light, the charge causes avalanche multiplication, and an avalanche current is generated.

Operation modes in a case where the reverse bias voltage is supplied to the APD 201 include a Geiger mode and a linear mode. The Geiger mode is a mode in which the anode and the cathode are operated at a potential difference higher than a breakdown voltage, and the linear mode is a mode in which the anode and the cathode are operated at a potential difference close to or lower than the breakdown voltage.

The APD operated in the Geiger mode is referred to as a single photon avalanche diode (SPAD). The APD 201 may be operated in the linear mode or the Geiger mode. In the case of the SPAD, the potential difference is higher than that of the APD in the linear mode, and an effect of the avalanche multiplication becomes remarkable, so that the SPAD is preferable.

The quenching element 202 functions as a load circuit (quenching circuit) at the time of signal multiplication by the avalanche multiplication. In addition, the quenching element 202 suppresses a voltage supplied to the APD 201 to suppress the avalanche multiplication (quenching operation). In addition, the quenching element 202 returns the voltage supplied to the APD 201 to the voltage VH by applying a current corresponding to a voltage drop due to the quenching operation (recharging operation). The quenching element 202 may be, for example, a resistor element or a transistor.

The waveform shaping unit 210 shapes a potential change of the cathode of the APD 201 obtained at the time of photon detection, and outputs a pulse signal. For example, an inverter circuit is used as the waveform shaping unit 210. Although FIG. 4 illustrates an example in which one inverter is used as the waveform shaping unit 210, a circuit in which a plurality of inverters are connected in series may be used as the waveform shaping unit 210, or another circuit having a waveform shaping effect may be used as the waveform shaping unit 210.

The counter circuit 211 counts the pulse signal output from the waveform shaping unit 210 and holds a digital signal indicating a count value. Furthermore, when the control signal is supplied from the vertical scanning circuit 110 via the drive line 213, the counter circuit 211 resets the held signal.

The selection circuit 212 is supplied with the control signal from the vertical scanning circuit 110 illustrated in FIG. 3 via the drive line 214 illustrated in FIG. 4. The selection circuit 212 switches between electrical connection and disconnection between the counter circuit 211 and the pixel output signal line 113 in response to the control signal. The selection circuit 212 includes, for example, a buffer circuit or the like for outputting a signal corresponding to a value held in the counter circuit 211.

In the example of FIG. 4, the selection circuit 212 switches between electrical connection and disconnection between the counter circuit 211 and the pixel output signal line 113, but a method of controlling signal output to the pixel output signal line 113 is not limited thereto. For example, a switch such as a transistor may be disposed at a node between the quenching element 202 and the APD 201, between the photoelectric conversion unit 102 and the pixel signal processing unit 103, or the like, and the signal output to the pixel output signal line 113 may be controlled by switching between electrical connection and disconnection. Furthermore, the signal output to the pixel output signal line 113 may be controlled by changing a value of the voltage VH or the voltage VL supplied to the photoelectric conversion unit 102 using a switch such as a transistor.

FIG. 4 illustrates a configuration example using the counter circuit 211. However, a pulse detection timing may be acquired using a time-to-digital conversion circuit (time to digital converter (TDC)) and a memory instead of the counter circuit 211. At this time, a generation timing of the pulse signal output from the waveform shaping unit 210 is converted into a digital signal by the TDC. In this case, a control signal (reference signal) can be supplied from the vertical scanning circuit 110 of FIG. 3 to the TDC via the drive line. The TDC acquires, as a digital signal, a signal indicating a relative time of an input timing of a pulse with reference to the control signal. The arrangement of the pixel output signal lines 113, the arrangement of the reading circuit 112, and the arrangement of the output circuit 114 are not limited to those in the example illustrated in FIG. 3. For example, the pixel output signal line 113 may extend in a row direction, and the reading circuit 112 may be connected to the pixel output signal line 113 extending in the row direction.

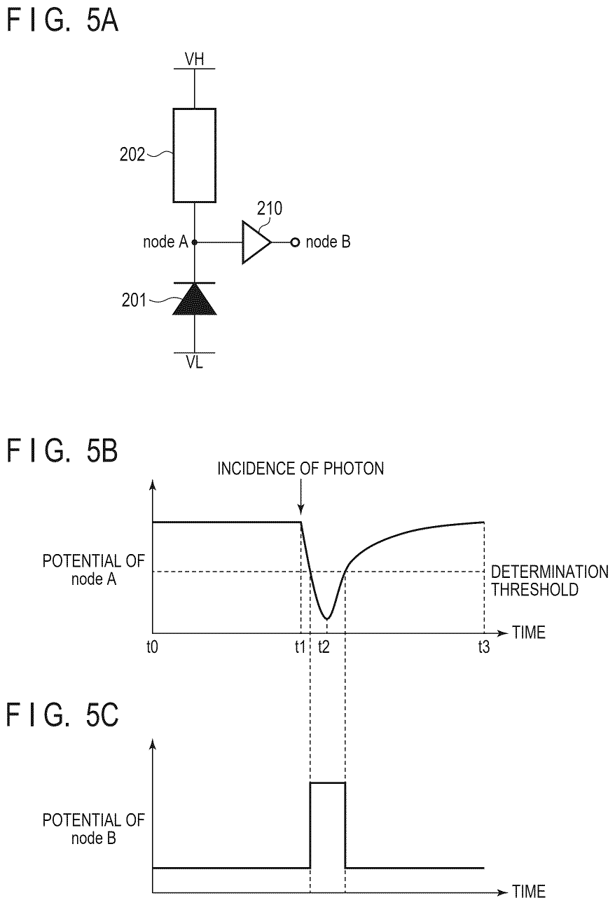

FIGS. 5A, 5B, and 5C are diagrams for describing an operation of the APD 201 according to the present embodiment. FIG. 5A is a diagram illustrating the APD 201, the quenching element 202, and the waveform shaping unit 210 extracted in FIG. 4. As illustrated in FIG. 5A, a connection node of the input terminals of the APD 201, the quenching element 202, and the waveform shaping unit 210 is a node A. Furthermore, as illustrated in FIG. 5A, an output side of the waveform shaping unit 210 is set as a node B.

FIG. 5B is a graph illustrating a temporal change of a potential of the node A in FIG. 5A. FIG. 5C is a graph illustrating a temporal change of a potential of the node B in FIG. 5A. In a period from time to t0 time t1, a voltage of VH-VL is applied to the APD 201 in FIG. 5A. When photons are incident on the APD 201 at time t1, the avalanche multiplication occurs in the APD 201. As a result, the avalanche current flows through the quenching element 202, and the potential of the node A drops. Thereafter, a potential drop amount further increases, and the voltage applied to the APD 201 gradually decreases. Then, at time t2, the avalanche multiplication in the APD 201 stops. As a result, a voltage level of the node A does not drop to be lower than a certain value. Thereafter, in a period from time t2 to time t3, a current compensating for the voltage drop flows from a node of the voltage VH to the node A, and the node A settles back to an original potential at time t3.

In the above-described process, the potential of the node B becomes high in a period in which the potential of the node A is lower than a certain threshold. In this way, a waveform of the potential drop of the node A caused by the incidence of the photons is shaped by the waveform shaping unit 210 and output as a pulse to the node B.

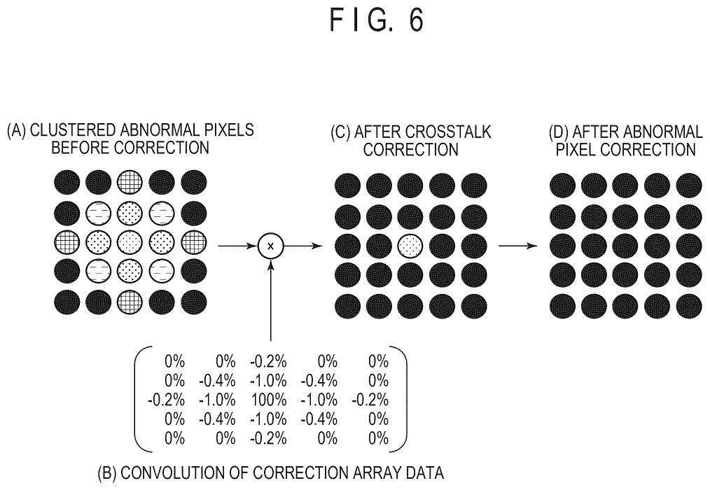

Next, the information processing device according to the present embodiment will be described with reference to FIGS. 6 to 8. The information processing device according to the present embodiment is a device that corrects array data based on pixel values output from the plurality of pixels 101 in the photoelectric conversion device described with reference to FIGS. 1 to 5C. First, an outline of processing executed by the information processing device according to the present embodiment will be described with reference to FIG. 6. FIG. 6 is a schematic explanatory diagram illustrating correction processing executed in the information processing device according to the present embodiment.

An abnormal pixel to be corrected in the present embodiment will be described. The abnormal pixel means a pixel having an unusual pixel value as compared with surrounding pixels of the pixel. Hereinafter, an abnormal pixel having a significantly larger pixel value than those of surrounding pixels will be mainly described. However, a pixel having a significantly smaller pixel value than those of surrounding pixels can also be referred to as the abnormal pixel.

Examples of a correction method for the abnormal pixel include a method of extracting a pixel having a pixel value significantly different from those of neighboring pixels as the abnormal pixel and replacing the pixel value of the abnormal pixel with an average value or a median value of pixel values of a plurality of pixels around the abnormal pixel. For example, in the photoelectric conversion device using the APD, crosstalk may occur due to an avalanche light emission phenomenon when charges generated by the avalanche multiplication are recombined. When the crosstalk occurs, the abnormal pixel affects characteristics of the plurality of pixels, as a result of which an image in which a plurality of abnormal pixels occur may be generated. Such abnormal pixels are referred to as clustered abnormal pixels. Note that a device in which the clustered abnormal pixels due to the crosstalk may occur is not limited to the photoelectric conversion device using the APD. The clustered abnormal pixels may also occur in a complementary metal-oxide-semiconductor (CMOS) sensor.

Processing A of FIG. 6 schematically illustrates a distribution of pixel values around the clustered abnormal pixels before correction included in the image data based on an output signal of the photoelectric conversion device 100. Circles illustrated in a matrix form in the processing A of FIG. 6 indicate the pixels. Hatching applied to each pixel in the processing A of FIG. 6 schematically indicates the pixel value. That is, the closer the hatching is to white, the larger the pixel value is, and the closer the hatching is to black, the smaller the pixel value is. In the processing A of FIG. 6, the white pixel at the center is the abnormal pixel having a large pixel value. Furthermore, in the processing A of FIG. 6, the abnormal pixel at the center affects two pixels in each of upper, lower, left, and right directions and four pixels disposed diagonally relative to the defective pixel at the center due to the crosstalk. As described above, a certain abnormal pixel may also affect surrounding pixels due to the crosstalk.

Processing B of FIG. 6 schematically illustrates processing of correcting an influence of the crosstalk on such clustered abnormal pixels. In this processing, two-dimensional array data including the clustered abnormal pixels is multiplied by two-dimensional correction array data acquired in advance. As a result, image data in which the influence of the crosstalk is corrected is generated as illustrated in processing C of FIG. 6. In the image data after the crosstalk correction, an influence of the abnormal pixel on the surrounding pixels is reduced although the abnormal pixel at the center remains.

Here, the correction array data indicates an influence of one pixel from surrounding pixels as a matrix of crosstalk probabilities (crosstalk matrix). Furthermore, “multiplication” can include arithmetic processing of multiplying an element of an array of the image data by an element of the correction array data. For example, “multiplication” may include an arithmetic operation of multiplying each element of the crosstalk matrix by a constant using a numerical value based on the pixel value of the abnormal pixel, or may include a convolution operation or the like using a fast Fourier transform or the like. The processing B of FIG. 6 illustrates an example of the convolution operation and an example of a matrix used for the convolution operation.

Thereafter, as illustrated in processing D of FIG. 6, correction is performed on the image data subjected to the crosstalk correction to replace the pixel value of the abnormal pixel with the average value or the median value of the pixel values of the plurality of surrounding pixels. The clustered abnormal pixels are corrected by the above procedure.

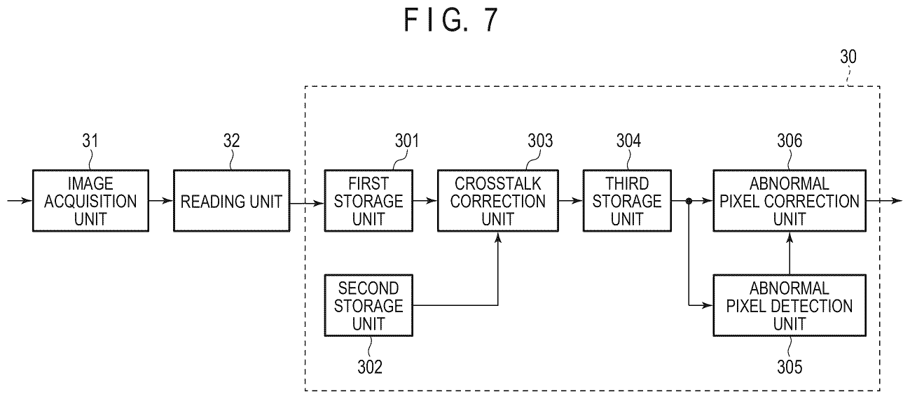

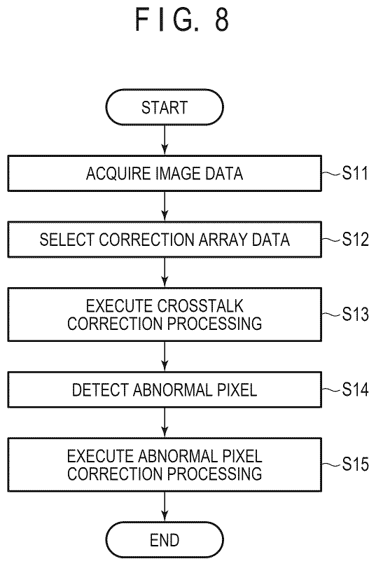

Next, the correction processing of FIG. 6 will be described more specifically with reference to FIGS. 7 and 8. FIG. 7 is a block diagram of the photoelectric conversion system according to the present embodiment. The photoelectric conversion system includes an information processing device 30, an image acquisition unit 31, and a reading unit 32.

The image acquisition unit 31 and the reading unit 32 correspond to the photoelectric conversion device described above. The image acquisition unit 31 is, for example, the plurality of pixels 101 illustrated in FIG. 2. The reading unit 32 is, for example, the pixel signal processing unit 103, the vertical scanning circuit 110, the horizontal scanning circuit 111, the reading circuit 112, the pixel output signal line 113, the output circuit 114, and the control signal generation unit 115 illustrated in FIGS. 3 and 4. The image data generated by the image acquisition unit 31 and the reading unit 32 is input to the information processing device 30.

The information processing device 30 is a device that processes the image data acquired by the image acquisition unit 31 and the reading unit 32. The information processing device 30 reads and executes a computer-executable instruction. The information processing device 30 can be a computer including one or more processors and one or more memories. The information processing device 30 may include a plurality of separated computers or may include a plurality of separated processors. Furthermore, the information processing device 30 may be implemented by one or more processing circuits. The processor or circuit can include a central processing unit (CPU), a micro processing unit (MPU), a graphics processing unit (GPU), an application specific integrated circuit (ASIC), or a field programmable gate array (FPGA). The processor or circuit can also include a digital signal processor (DSP), a data flow processor (DFP), or a neural processing unit (NPU).

The information processing device 30 includes a first storage unit 301, a second storage unit 302, a crosstalk correction unit 303, a third storage unit 304, an abnormal pixel detection unit 305, and an abnormal pixel correction unit 306. The first storage unit 301, the second storage unit 302, and the third storage unit 304 can be implemented by memories such as static RAMs (SRAMs), for example. Functions of the crosstalk correction unit 303, the abnormal pixel detection unit 305, and the abnormal pixel correction unit 306 can be implemented, for example, by the processor reading a computer-executable instruction from the memory and executing the computer-executable instruction.

FIG. 8 is a flowchart of processing executed in the photoelectric conversion system according to the present embodiment. The processing according to the present embodiment will be described in more detail with reference to FIGS. 7 and 8.

In step S11, the image acquisition unit 31 outputs, based on incident light, a signal based on the incident light incident on the plurality of pixels 101, and the reading unit 32 acquires image data based on the signal from the image acquisition unit 31. The first storage unit 301 stores the image data (first array data). The image data stored in the first storage unit 301 is array data including the pixel values of the plurality of pixels 101.

In step S12, the crosstalk correction unit 303 selects correction array data (second array data) to be used for crosstalk correction processing. The second storage unit 302 stores one or more types of correction array data in advance. In a case where there is one type of correction array data held in the second storage unit 302, the crosstalk correction unit 303 selects the one type of correction array data. In a case where there are a plurality of types of correction array data held in the second storage unit 302, the crosstalk correction unit 303 selectively acquires one type among the plurality of types of correction array data based on a setting value, a photographing environment, and the like, and executes the processing.

The correction array data is crosstalk matrix data of N rows and M columns. One of the number of rows N and the number of columns M is an integer of 2 or more, and the other is an integer of 1 or more. That is, the correction array data may be one-dimensional or two-dimensional as long as the correction array data includes two or more elements.

Both the number of rows N and the number of columns M are preferably integers of 3 or more. In other words, the correction array data preferably has a size of three rows and three columns or more. In this case, pixel data to be corrected also has a size of three rows and three columns or more. As a result, since pixels adjacent to one pixel in eight directions are considered at the time of correction, the crosstalk correction of the pixels around the abnormal pixel can be performed with high accuracy. In addition, the number of rows N and the number of columns M are both preferably odd numbers. Since the crosstalk probability is symmetric in the row direction and a column direction around the abnormal pixel that is a cause of the crosstalk, the correction can be efficiently performed when the number of rows N and the number of columns M are odd numbers.

In step S13, the image data stored in the first storage unit 301 and the correction array data stored in the second storage unit 302 are input to the crosstalk correction unit 303 (first arithmetic operation unit). The crosstalk correction unit 303 executes the crosstalk correction processing of correcting the image data based on the correction array data. Crosstalk-corrected image data (third array data) obtained by the processing is stored in the third storage unit 304. As described above, the crosstalk correction processing can be processing of performing the convolution operation on the crosstalk matrix that is the correction array data for a matrix of the image data. However, the crosstalk correction processing is not limited to the convolution operation as long as the crosstalk can be corrected by using one pixel (first target pixel), a pixel (second target pixel) adjacent to the one pixel, and second array data including a plurality of coefficients. By the processing of step S13, correction is performed to bring the clustered abnormal pixels in the image data closer to the isolated abnormal pixel as illustrated in the processing C of FIG. 6.

In step S14, the abnormal pixel detection unit 305 (second arithmetic operation unit) detects an abnormal pixel (third target pixel) from the crosstalk-corrected image data stored in the third storage unit 304, and outputs a detection result to the abnormal pixel correction unit 306. Abnormal pixel detection processing can be processing of detecting the abnormal pixel based on the pixel value of the crosstalk-corrected image data. Furthermore, the abnormal pixel detection processing may be processing of detecting the abnormal pixel based on position information of the abnormal pixel acquired in advance, or may be processing of treating both the known abnormal pixel and the abnormal pixel detected from the crosstalk-corrected image data as the abnormal pixels.

In step S15, the abnormal pixel correction unit 306 (third arithmetic operation unit) executes abnormal pixel correction processing on the crosstalk-corrected image data. The abnormal pixel correction unit 306 performs correction to replace a pixel value of a pixel detected as the abnormal pixel by the abnormal pixel detection unit 305 with an average value or a median value of a plurality of pixel values of surrounding pixels. As a result, the abnormal pixel can be corrected as illustrated in the processing D of FIG. 6.

As described above, the information processing device 30 according to the present embodiment corrects the pixels around the abnormal pixel by the crosstalk correction processing for the image data, and then corrects the abnormal pixel. That is, a narrow range of correction for correcting the isolated abnormal pixel is performed after a wide range of correction for correcting the clustered abnormal pixels occurring over a wide range. Effects obtained by performing the two-stage correction in this order will be described.

The crosstalk may be caused by the abnormal pixel, and in this case, the clustered abnormal pixels occur. In the correction of the image data including such clustered abnormal pixels, it is desirable to consider the influence of the abnormal pixel at the time of the arithmetic operation of the crosstalk correction processing. For example, in a case where the crosstalk correction processing is executed after the correction of the abnormal pixel, some abnormal pixels of the clustered abnormal pixels disappear at the time of the crosstalk correction processing. In such a case, since the lost abnormal pixel is not considered at the time of the crosstalk correction processing, there may be a case where sufficient correction accuracy is not secured.

On the other hand, in the present embodiment, since the crosstalk correction processing is executed before the correction of the abnormal pixel, the influence of the crosstalk caused by the abnormal pixel is appropriately corrected. Therefore, according to the present embodiment, the information processing device 30 and an information processing method with improved correction accuracy are provided. A processing order of executing the crosstalk correction processing before the correction of the abnormal pixel according to the present embodiment can be more generally rephrased as executing the correction processing in the order opposite to the order of noise occurrence. As a result, appropriate correction can be performed even in a case where noises due to a plurality of factors overlap such that certain noise causes another noise.

### Second Embodiment

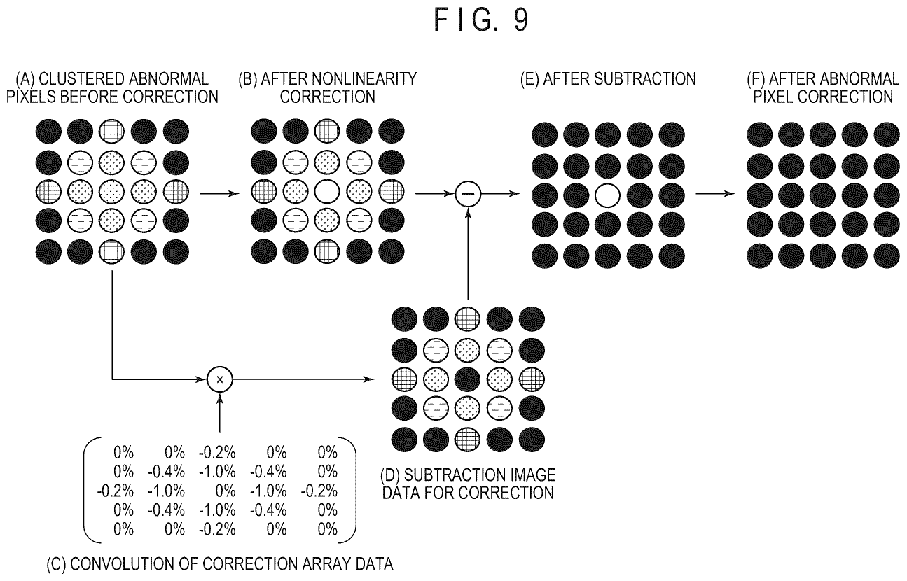

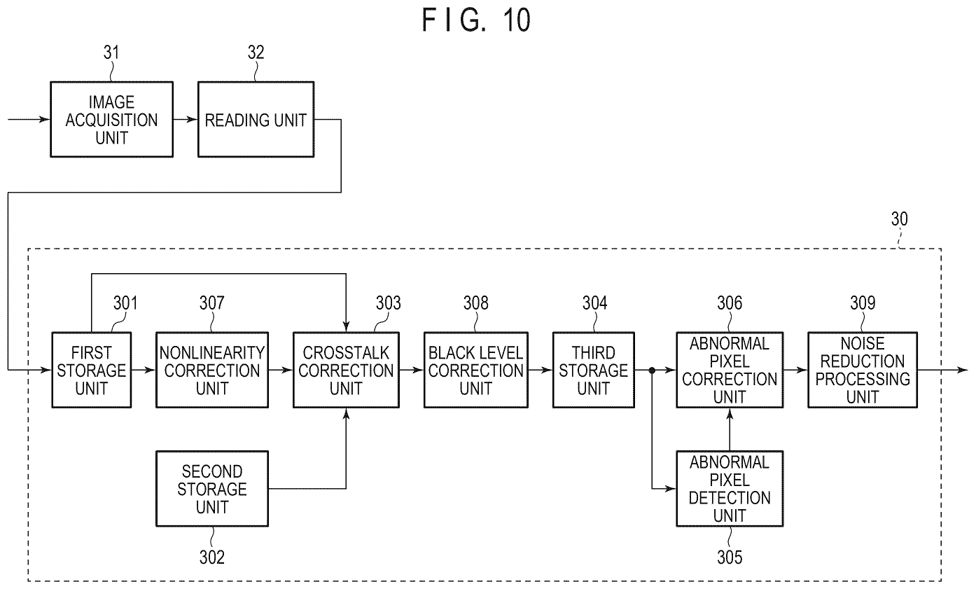

In the present embodiment, a modified example of the correction processing according to the first embodiment will be described with reference to FIGS. 9 to 11. In the present embodiment, a description of elements common to the first embodiment may be omitted or simplified.

First, an outline of processing executed by an information processing device according to the present embodiment will be described with reference to FIG. 9. FIG. 9 is a schematic explanatory diagram of correction processing executed in the information processing device according to the present embodiment.

Similarly to the processing A of FIG. 6, processing A of FIG. 9 schematically illustrates a distribution of pixel values around clustered abnormal pixels included in image data based on an output signal of a photoelectric conversion device 100. In the present embodiment, as illustrated in processing B of FIG. 9, nonlinearity correction processing is executed for such image data. In addition, as illustrated in processing C of FIG. 9, multiplication (convolution) of correction array data is performed on the image data before the correction in parallel with the nonlinearity correction processing. By the multiplication, subtracted image data for crosstalk correction processing is generated as illustrated in processing D of FIG. 9. Thereafter, the crosstalk correction processing is executed by subtracting the subtracted image data of the processing D of FIG. 9 from the image data after the nonlinearity correction processing of the processing B of FIG. 9 as illustrated in processing E of FIG. 9.

Thereafter, as illustrated in processing F of FIG. 9, correction is performed on the image data subjected to the crosstalk correction to replace a pixel value of an abnormal pixel with an average value or a median value of a plurality of pixel values of surrounding pixels. The clustered abnormal pixels are corrected by the above procedure.

An effect obtained by executing the nonlinearity correction processing and an effect obtained by generating the subtracted image data from the image data before the nonlinearity correction processing is executed will be described. An example of a configuration of the photoelectric conversion device 100 that acquires the image data includes a circuit configuration using an APD 201 including an active recharge type drive circuit represented by a clock recharge type. In the photoelectric conversion device 100 using the active recharge type drive circuit, a recharging operation of resetting the APD 201 to a state in which avalanche multiplication is possible is performed at a predetermined cycle. In the photoelectric conversion device 100 using such an active recharge type drive circuit, a pile-up phenomenon may occur. When the pile-up phenomenon occurs, some incident photons may not be appropriately counted, and a response characteristic of a count value of the number of incident photons may become nonlinear. Furthermore, the response characteristic may become nonlinear due to an influence of a dead time in which counting of the photons is not performed depending on the configuration or driving method of the photoelectric conversion device 100. As described above, the response characteristic of the photoelectric conversion device 100 may have nonlinearity. Therefore, it is desirable to execute the nonlinearity correction processing that brings the response characteristic close to linear.

A nonlinear response function indicating the above-described nonlinear response can be expressed by the following Formula (1).

$$f ( x ) = fT \times ( 1 - {e}^{- \frac{x}{fT}} ) \qquad ( 1 )$$

In Formula (1), x represents an input (the number of incident photons), f(x) represents an output (count value), f represents a recharge frequency, T represents an exposure time, and e represents a base of a natural logarithm.

Here, a relationship between the count value measured in a situation where crosstalk occurs and the number of incident photons will be described. Nct=f(Nph), in which Nct represents the count value, and Nph represents the number of incident photons. At this time, the amount of light emission due to the crosstalk is proportional to the count value Nct, not the number of incident photons Nph. On the other hand, the total count value Nct′ of the photons incident on the pixel that receives the crosstalk is expressed as Nct′=f(Nc+Ns) using the sum Nc+Ns, in which Nc represents the number of false signal photons caused by the crosstalk, Ns represents the number of signal photons. Therefore, when estimating a distribution of the false signal photons caused by the crosstalk, in a case where the estimation is performed based on the count value after the nonlinearity correction, there is a possibility that an error with an actual distribution of the false signal photons increases.

In consideration of the above, it is more appropriate to estimate the distribution of the false signal photons caused by the crosstalk based on the count value before the nonlinearity correction. Therefore, in the present embodiment, the subtracted image data for correction (the processing D of FIG. 9) is generated based on the pixel data before the nonlinearity correction (the processing A of FIG. 9). By subtracting the subtracted image data for correction obtained in this manner from the image data after the nonlinearity correction, an influence of correction accuracy deterioration of the clustered abnormal pixels due to the nonlinearity is reduced even in a situation where there is a pixel having a higher pixel value and an influence of the nonlinearity occurs. Therefore, the correction can be performed with high accuracy even in a case where the clustered abnormal pixels are close, a case where a signal light quantity corresponding to a subject is large, or the like.

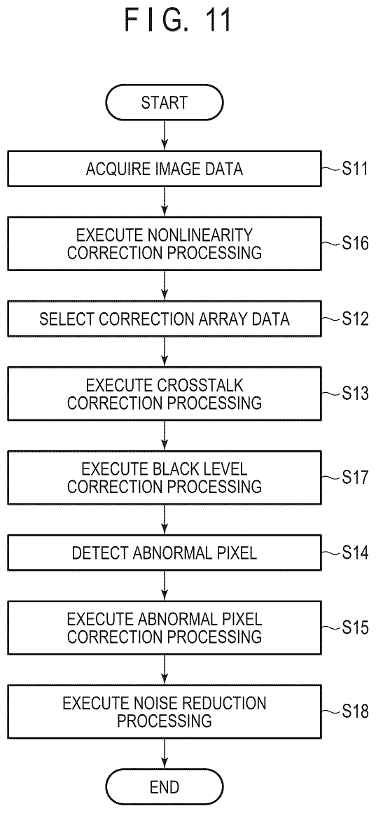

Next, the correction processing of FIG. 9 will be described more specifically with reference to FIGS. 10 and 11. FIG. 10 is a block diagram of a photoelectric conversion system according to the present embodiment. An information processing device 30 of the present embodiment further includes a nonlinearity correction unit 307, a black level correction unit 308, and a noise reduction processing unit 309 in addition to the configuration illustrated in FIG. 7. Functions of the nonlinearity correction unit 307, the black level correction unit 308, and the noise reduction processing unit 309 can be implemented, for example, by a processor reading a computer-executable instruction from a memory and executing the computer-executable instruction.

FIG. 11 is a flowchart of processing executed in the photoelectric conversion system according to the present embodiment. The processing according to the present embodiment will be described in more detail with reference to FIGS. 10 and 11.

In step S11, image data (first array data) is stored in a first storage unit 301 as in FIG. 9.

In step S16, the nonlinearity correction unit 307 (sixth arithmetic operation unit) executes the nonlinearity correction processing on the image data stored in the first storage unit. As described above, the response characteristic of the photoelectric conversion device 100 may be nonlinear. In this case, when correction based on the linear response is performed at the time of the crosstalk correction processing, overcorrection may occur. Therefore, in the present embodiment, the nonlinearity correction unit 307 positioned upstream of the crosstalk correction unit 303 executes the nonlinearity correction processing on the image data before the crosstalk correction processing is executed. As a result, an influence of the overcorrection on a signal quality can be reduced. The nonlinearity correction processing is executed, for example, by referring to a lookup table indicating a correspondence relationship between an input pixel value and an output pixel value.

In step S12, the crosstalk correction unit 303 selects correction array data (second array data) to be used for crosstalk correction processing.

In step S13, the image data before the nonlinearity correction processing stored in the first storage unit 301, the correction array data stored in the second storage unit 302, and image data after the nonlinearity correction processing are input to the crosstalk correction unit 303. The crosstalk correction unit 303 performs convolution of the correction array data with respect to the image data before the nonlinearity correction processing to generate the subtracted image data for the crosstalk correction processing. The crosstalk correction unit 303 generates image data after the crosstalk correction by subtracting the subtracted image data from the image data after the nonlinearity correction processing.

In step S17, the black level correction unit 308 (fourth arithmetic operation unit) executes black level correction processing of correcting a black level by subtracting a predetermined correction value corresponding to the black level from a pixel value of the image data after the crosstalk correction. An image after the black level correction is stored in the third storage unit 304. A correction value used for the black level correction processing can be generated based on, for example, a pixel value output from a light-shielded pixel included in an optical black (OB) region in which a light incident surface side is shielded by a light shielding film in a pixel region 12. Furthermore, a value used for the black level correction processing may be generated based on a frequency distribution of pixel values output from a plurality of light-shielded pixels. Furthermore, the black level correction unit 308 may acquire the correction value by referring to a lookup table in which temperature information and the correction value are associated with each other based on the temperature information output from a temperature sensor mounted on the photoelectric conversion device 100.

Instead of the processing of step S17, processing of adding the correction value for the black level correction to the subtracted image data may be added to the processing of step S13. The black level correction can also be performed in this configuration.

The black level correction processing of step S17 may be executed before the crosstalk correction processing of step S13. However, a pixel value of a pixel that causes the crosstalk includes an influence of the black level, and the crosstalk to surrounding pixels contains a contribution from the black level. Therefore, it is desirable that the black level correction processing is executed after the crosstalk correction processing. As a result, since the crosstalk correction processing can be executed on the image data containing the contribution of the black level, the influence of the crosstalk is appropriately corrected in a state in which the contribution of the black level is also taken into consideration.

In step S14, the abnormal pixel detection unit 305 executes abnormal pixel detection processing for the image data after the black level correction stored in the third storage unit 304. Then, in step S15, the abnormal pixel correction unit 306 executes the abnormal pixel correction processing for the image data after the black level correction. Contents of the steps of processing are the same as those in the first embodiment.

In the abnormal pixel detection processing in step S14, when the image data contains the influence of the black level, accuracy in detecting the abnormal pixel having a smaller pixel value decreases. Therefore, it is desirable that the black level correction processing of step S17 is executed before the abnormal pixel detection processing of step S14. This makes it possible to accurately detect and correct the abnormal pixel having a smaller pixel value.

In step S18, the noise reduction processing unit 309 (fifth arithmetic operation unit) executes noise reduction processing of reducing noise other than the clustered abnormal pixels for the image data after the abnormal pixel correction processing. Examples of the noise to be processed in the noise reduction processing include thermal noise, random noise due to statistical fluctuation, and the like. As a result, the noises caused by these factors are reduced. The noise reduction processing can be, for example, smoothing processing using a spatial filter. By executing the smoothing processing, thermal noise, random noise, and the like can be reduced. Alternatively, the noise reduction processing may be processing using a noise reduction processing model generated by machine learning such as deep learning.

In a case where the noise reduction processing of step S18 is executed before the abnormal pixel detection processing of step S14, accuracy in detecting the abnormal pixel decreases. Therefore, it is desirable that the noise reduction processing of step S18 is executed after the abnormal pixel detection processing of step S14. This makes it possible to accurately detect and correct the abnormal pixel. In the present embodiment, the noise reduction processing of step S18 is executed after the abnormal pixel correction processing of step S15, but the order of the processing is not limited thereto. The noise reduction processing of step S18 may be executed after the abnormal pixel detection processing of step S14, and then the abnormal pixel correction processing of step S15 may be executed.

According to the present embodiment, similarly to the first embodiment, the information processing device 30 and an information processing method with improved correction accuracy are provided. Furthermore, according to the present embodiment, overcorrection at the time of the crosstalk correction processing can be suppressed by executing the nonlinearity correction processing before the crosstalk correction processing. Furthermore, according to the present embodiment, since the black level correction processing is executed before the abnormal pixel detection processing, the accuracy in detecting the abnormal pixel can be improved. Furthermore, according to the present embodiment, the signal quality can be improved by executing the noise reduction processing.

### Third Embodiment

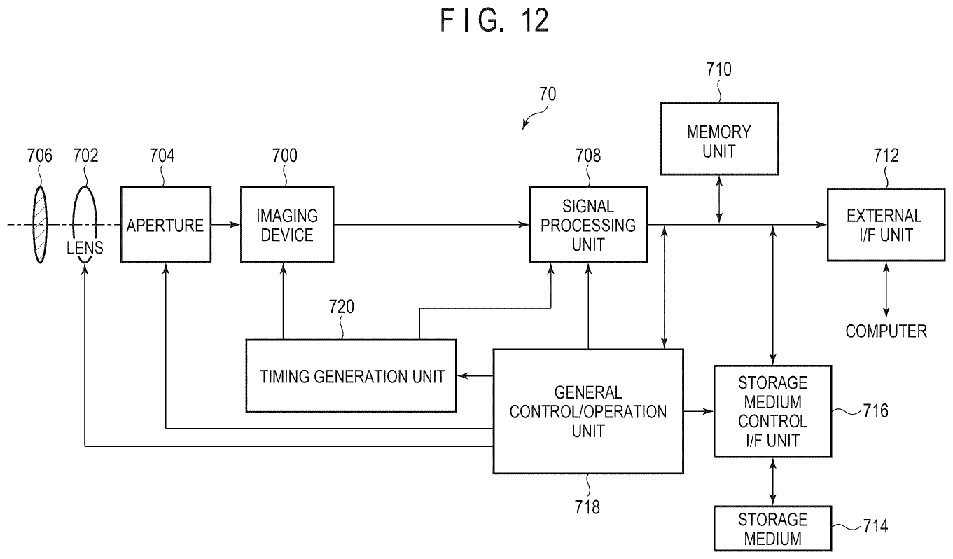

The information processing device 30 and the photoelectric conversion system of the above embodiments can be applied to various equipment. Examples of the equipment include a digital still camera, a digital camcorder, a camera head, a copying machine, a facsimile, a mobile phone, a vehicle-mounted camera, an observation satellite, and a surveillance camera. FIG. 12 is a block diagram of a digital still camera as an example of equipment. FIG. 12 illustrates an example in which the photoelectric conversion system illustrated in FIG. 7 is applied to a digital still camera.

The equipment 70 illustrated in FIG. 12 includes a barrier 706, a lens 702, an aperture 704, and an imaging device 700 (an example of the photoelectric conversion device 100 or the photoelectric conversion system). The equipment 70 further includes a signal processing unit (processing device) 708, a timing generation unit 720, a general control/operation unit 718 (control device), a memory unit 710 (storage device), a storage medium control I/F unit 716, a storage medium 714, and an external I/F unit 712. The information processing device 30 of the above embodiments may be included in the imaging device 700 or may be included in the signal processing unit 708. At least one of the barrier 706, the lens 702, and the aperture 704 is an optical device corresponding to the equipment. The barrier 706 protects the lens 702, and the lens 702 forms an optical image of an object on the imaging device 700. The aperture 704 varies the amount of light passing through the lens 702. The imaging device 700 is configured as in the above embodiments, and converts an optical image formed by the lens 702 into image data (image signal). The signal processing unit 708 performs various corrections, data compression, and the like on the image data output from the imaging device 700. The timing generation unit 720 outputs various timing signals to the imaging device 700 and the signal processing unit 708. The general control/operation unit 718 controls the entire digital still camera, and the memory unit 710 temporarily stores image data. The storage medium control I/F unit 716 is an interface for storing or reading image data on the storage medium 714, and the storage medium 714 is a detachable storage medium such as a semiconductor memory for storing or reading image data. The external I/F unit 712 is an interface for communicating with an external computer or the like. The timing signal or the like may be input from the outside of the equipment. The equipment 70 may further include a display device (a monitor, an electronic view finder, or the like) for displaying information obtained by the photoelectric conversion device. The equipment includes at least a photoelectric conversion device. Further, the equipment 70 includes at least one of an optical device, a control device, a processing device, a display device, a storage device, and a mechanical device that operates based on information obtained by the photoelectric conversion device. The mechanical device is a movable portion (for example, a robot arm) that receives a signal from the photoelectric conversion device for operation.

Each pixel may include a plurality of photoelectric conversion units (a first photoelectric conversion unit and a second photoelectric conversion unit). The signal processing unit 708 may be configured to process a pixel signal based on charges generated in the first photoelectric conversion unit and a pixel signal based on charges generated in the second photoelectric conversion unit, and acquire distance information from the imaging device 700 to an object.

### Fourth Embodiment

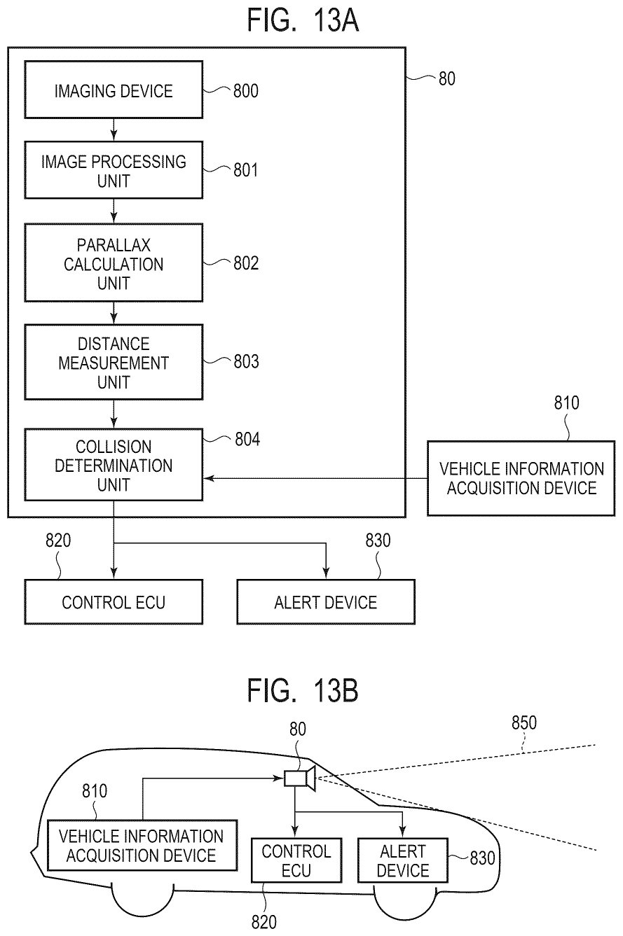

FIGS. 13A and 13B are block diagrams of equipment relating to the vehicle-mounted camera according to the present embodiment. FIGS. 13A and 13B illustrate an example in which the photoelectric conversion system illustrated in FIG. 7 is applied to a movable body such as a vehicle. The equipment 80 includes an imaging device 800 (an example of the photoelectric conversion device 100 or the photoelectric conversion system) and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80. The information processing device 30 of the above embodiments may be included in the imaging device 800 or may be included in the image processing unit 801. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 13B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-029712, filed Feb. 29, 2024, which is hereby incorporated by reference herein in its entirety.

What is claimed is:

1. An information processing device comprising:
a first storage unit configured to store first array data based on a pixel value output from each of a plurality of pixels;
a second storage unit configured to store second array data including a plurality of coefficients used for correcting the pixel value;
a first arithmetic operation unit configured to correct a pixel value of a first target pixel in the first array data, based on the pixel value of the first target pixel, a pixel value of a second target pixel adjacent to the first target pixel in the first array data, and the second array data;
a third storage unit configured to store third array data based on the pixel value output from the first arithmetic operation unit;
a second arithmetic operation unit configured to detect a third target pixel from the third array data; and
a third arithmetic operation unit configured to correct a pixel value of the third target pixel based on the third array data.

2. The information processing device according to claim 1, wherein the correction in the first arithmetic operation unit includes multiplication of the pixel value of the first array data and the coefficient of the second array data.

3. The information processing device according to claim 1, wherein the correction in the first arithmetic operation unit includes a convolution operation of the first array data and the second array data.

4. The information processing device according to claim 1, wherein the number of rows and the number of columns of the second array data are both 3 or more.

5. The information processing device according to claim 4, wherein the number of rows and the number of columns of the second array data are both odd numbers.

6. The information processing device according to claim 1, wherein the correction in the third arithmetic operation unit includes processing of replacing the pixel value of the third target pixel with another value.

7. The information processing device according to claim 6, wherein the correction in the third arithmetic operation unit includes processing of replacing the pixel value of the third target pixel with an average value or a median value of pixel values of a plurality of pixels around the third target pixel.

8. The information processing device according to claim 1 further comprising a fourth arithmetic operation unit configured to subtract a black level from the pixel value output from the first arithmetic operation unit, wherein the third array data is generated based on a pixel value obtained after the black level is subtracted.

9. The information processing device according to claim 8, wherein the black level is calculated based on a pixel value output from a light-shielded pixel.

10. The information processing device according to claim 1 further comprising a fifth arithmetic operation unit configured to execute noise reduction processing for an output of the second arithmetic operation unit or the third arithmetic operation unit.

11. The information processing device according to claim 10, wherein the fifth arithmetic operation unit executes the noise reduction processing by smoothing processing using a spatial filter.

12. The information processing device according to claim 1 further comprising a sixth arithmetic operation unit configured to correct nonlinearity of the first array data before the correction in the first arithmetic operation unit.

13. The information processing device according to claim 12, wherein the correction in the first arithmetic operation unit is performed based on the first array data before the nonlinearity is corrected, the first array data after the nonlinearity is corrected, and the second array data.

14. The information processing device according to claim 1,
wherein the second storage unit includes a plurality of types of the second array data, and
wherein one of the plurality of types of the second array data is selectively input to the first arithmetic operation unit.

15. An information processing device comprising:
a first arithmetic operation unit configured to correct a pixel value of a first target pixel in first array data based on a pixel value output from each of a plurality of pixels, based on the pixel value of the first target pixel, a pixel value of a second target pixel adjacent to the first target pixel in the first array data, and second array data including a plurality of coefficients; and
a third arithmetic operation unit configured to correct a third target pixel detected from third array data based on a pixel value output from the first arithmetic operation unit.

16. A photoelectric conversion device comprising:
the information processing device according to claim 1; and
the plurality of pixels.

17. Equipment comprising:
the photoelectric conversion device according to claim 16; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

18. The equipment according to claim 17, wherein the processing device acquires distance information on a distance from the photoelectric conversion device to an object.

19. An information processing method comprising:
acquiring first array data based on a pixel value output from each of a plurality of pixels;
acquiring second array data including a plurality of coefficients used for correcting the pixel value;
correcting a pixel value of a first target pixel in the first array data, based on the pixel value of the first target pixel, a pixel value of a second target pixel adjacent to the first target pixel in the first array data, and the second array data;
acquiring third array data based on the corrected pixel value of the first target pixel;
detecting a third target pixel from the third array data; and
correcting a pixel value of the third target pixel based on the third array data.

20. A non-transitory storage medium storing a program for causing a computer to execute the information processing method according to claim 19.
